(19) United States
(12) Patent Application Publication
(10) Pub. No.: US 2012/0197891 A1
(43) Pub. Date: Aug. 2, 2012

(54) GENRE DISCOVERY ENGINES

(75) Inventors: Gregory T. Short, Carlsbad, CA (US); Geoffrey C. Zatkin, Encinitas, CA (US); Theodore Spence, Oceanside, CA (US)

(73) Assignee: ELECTRONIC ENTERTAINMENT DESIGN AND RESEARCH, Carlsbad, CA (US)

(21) Appl. No.: 13/357,438

(22) Filed: Jan. 24, 2012

Related U.S. Application Data
(60) Provisional application No. 61/436,782, filed on Jan. 27, 2011.

(51) Int. Cl. G06F 17/30

(52) U.S. Cl. 707/737; 707/E17.046

(57) ABSTRACT

Genre discovery engines are presented. A genre discovery engine can compare clusters of products falling within known genres to other clusters. Known genres can be defined in turns of correlated product properties. When a new cluster is identified falling outside the boundaries of known genres, the discovery engine can recommend that the new cluster might be a new genre.

This application claims the benefit of priority to U.S. provisional application having Ser. No. 61/436,782 filed on Jan. 27, 2011. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### Field of the Invention

The field of the invention is product marketing analytics technologies.

### Background

Products are often grouped into categories (e.g., genres, labels, verticals, etc.) to allow consumers to easily recognize a class of goods or services the products fall into. For example, novels can a categorized by genres: mystery, romance, science-fiction, history, fantasy, etc. Often, there are products which don't seem to fit into any category, or that are lumped into an existing category because they share some of the traits of other products in that category. This can make it hard to promote a product that doesn't quite fit into an existing category. Additionally, this can lead to consumers purchasing products which do not actually match their needs.

Ideally, product promoters would have access to a system that allows them to identify how goods or services fit within new product categories. Thus, there is still a need for identifying when a new product category has emerged, or is likely to emerge.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

### SUMMARY OF THE INVENTION

The inventive subject matter provides apparatus, systems and methods in which a new product category can be is identified as a genre by analyzing large data sets of products having common properties. The product category is euphemistically referred to as a “genre”. A genre can be discover by identifying one or more clusters of data points existing in a namespace at a fringe or outside previously categorized genres. Genres can comprise a broad spectrum of concepts including types of goods and services, types of movie, types of fiction, types of game, types of media, or other classifications. One aspect of the inventive subject matter includes a genre discovery engine capable of identifying new clusters of products outside known boundaries of existing known genres. Contemplated discovery engines comprises a product database storing product objects representative of known products where the product objects comprises a plurality of product properties. Discovery engines can further include a genre database storing known genre objects where each known genre objects has criteria defining the boundary a corresponding genre within a multi-dimensional product property namespace. A clustering engine can analyze products having one or more correlated product properties within the property namespace to see if products form clusters beyond the boundaries of the known genre objects. If a new cluster is found to fall outside defined criteria associated with known genres, the clustering engine can identify the new cluster as a possible definition for a new genre. A genre presentation interface, an HTTP server for example, can configure one or more output devices to present the new cluster.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of genre discovery ecosystem.

### DETAILED DESCRIPTION

It should be noted that while the following description is drawn to a computer/server based discovery engines, various alternative configurations are also deemed suitable and may employ various computing devices including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including generating signals comprising instructions for configuring an output device (e.g., computer, cell phone, printer, etc.) to present a cluster of products that appear to be related to an new category or genre of product.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of a networking ecosystem, “coupled to” and “coupled with” are used to euphemistically mean “communicatively coupled with”.

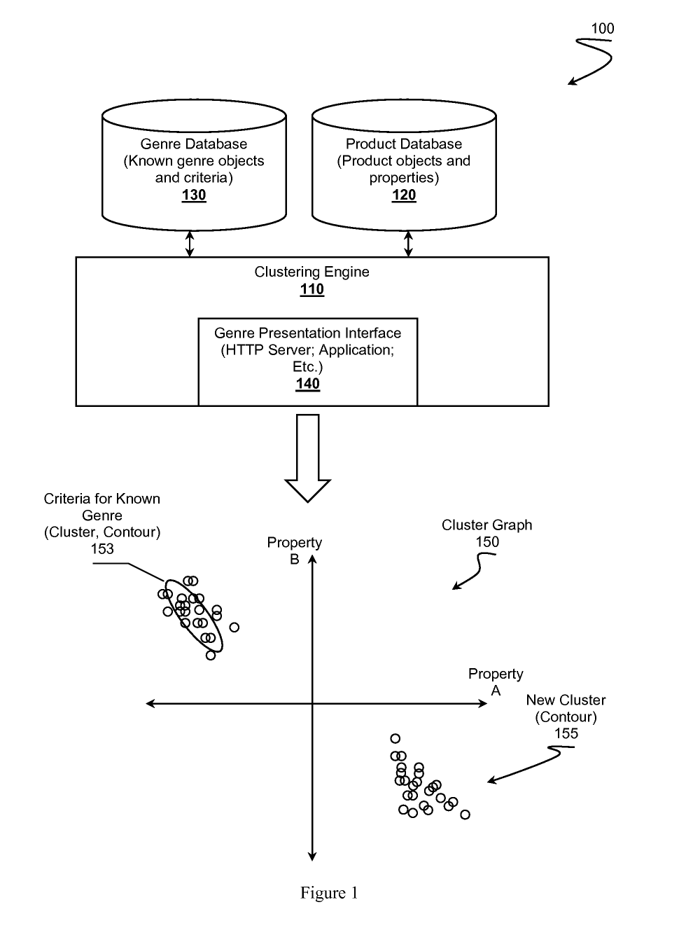

In FIG. 1 genre discovery engine 100 comprises product database 120, genre database 130, and clustering engine 110. Preferably discovery engine 100 further comprises a genre presentation interface 140, possibly functioning based on an HTTP server. In a preferred embodiment, discovery engine 100 operates as a for-fee service allowing users to analyze products within product database 120 with respect to properties associated with the products to determine if products form clusters. Clusters can be considered indicative of a group of products that correspond to a genre. Suitable technologies that can be adapted for use within the inventive subject include those disclosed in co-owned U.S. Pat. No. 7,580,853 to Short et al. titled “Methods of Providing a Marketing Guidance Report for a Proposed Electronic Game”, filed on Apr. 13, 2007. An example on-line service that can leverage the disclosed techniques includes those offered by Electronic Entertainment Design and Research (see URL www.eedar.com).

The following discussion presents the inventive subject matter from the perspective of video or computer games as products. One should appreciate that the subject matter can be easily extended to products, goods, or services beyond video games. For example, restaurants could be a type of product that could be targeted for analysis.

One aspect of the inventive subject matter includes methods or engines 100 configured to discover product categorizations or genres. As used herein the term “genre” is used euphemistically to refer to categorizations or classifications of products (e.g., video games, media outlets, etc.). Discovery engine 100 can be configured to aggregate data relating to one or more products from many different data sources, possibly including web sites, review sites, blog posts, auction sites, or even manually entered data into product database 120. The product information is preferably aggregated into one or more product objects representing products where the product objects also comprise product properties. Example product properties for a video game could include packaging size, weight, color use, specified genre, review score, release date, designer, art style, delivery method, distributor, branding, publisher, rating information, or other information relating to the video game. Discovery engine 100 can conduct one or more analyses to determine correlations among the product properties across similar products. The properties can from clusters or groups via the algorithms employed for the analyses as discussed in U.S. Pat. No. 7,580,853. Cluster graph 150 illustrates possible clusters.

Clusters can be considered indicative of a genre where a genre can be treated as a known genre object stored in genre database 130. Genre objects correspond to established clusters of products having correlated product properties where each genre object comprises defined criteria (e.g., boundaries, contours, etc.) as a function of the correlated product priorities. Consider an example of analyzing video games, analysis of many video games might reveal a clustering of games having been tagged with a “horror” keyword or concept as determined from scanning or analyzing blog posts. Such a cluster can be treated as a manageable data object representing a genre titled “horror”. For example, in cluster graph 150, the criteria for known genre 153 might form a boundary ellipse that depends on product properties A and B. One should appreciate criteria for known genre 153 is represented in two dimensions. However, criteria could be defined in many dimensions include two, three, four, or more dimensions. Further the criteria could change with time, possibly where criteria for known genre 153 might shift or move as new data becomes available or as markets shift in use of words describing products.

Many clusters have a priori defined genres assigned to them as indicated by criteria for known genre 153. However, when analyzing product properties (e.g., size, weight, theme, review score, relates date, art style, etc.), other clusters can appear that fall outside a known genre. A new cluster can be considered a newly discovered genre. New cluster 155 is illustrated on cluster graph 150 to indicate that it is newly discovered.

As mentioned briefly above one should note the clustering space can be considered a multi-dimensional space where each dimension can be considered an aspect of a product's properties. A cluster can appear in one cross section of the space, but might not appear in another cross section of the space. Contemplated clustering engines 110 are configured to identify clusters among the multiple dimensions, even when a single dimension is characterized by combinations of known properties regardless of dimensionality. Clustering engine 110 can identify new cluster 155 by seeking tight groupings in a projected view space of the cluster space.

Known genres can be considered to have defined boundaries within the product property space as illustrated by criteria for known genre 153. The boundaries can be defined algorithmically to be well defined or fuzzy as desired. New clusters can be found when a threshold of number members (e.g., 10, 20, 30, 50, etc.) appear relatively close to each other by a quantized metric (e.g., relevance, distances, etc.) and are considered to fall outside the defined criteria for the boundary of the known genre. In some embodiments, the boundaries can be defined as contours. Once discovered or identified, the newly discovered genre can be presented to a user via genre presentation interface 140. In the example shown, cluster graph 150 can be rendered within a browser for a remote user. Once discovered, the product objects having product properties that fall within the boundaries of the genre criteria can be linked to a newly created known genre objects.

The product property space can be represented by a normalized universal namespace where all product information has been normalized to a common format or schema. When product information is obtained, or other data for that matter, can be converted or translated into the normalized namespace so that all objects can be compared against each other.

The outlined approach has several distinct advantages. In view that the namespace can be formed based on universal properties, genres can be discovered across products that might not be normally considered related or across multiple product classification. For example, video games and clothing could fall within a “Zombie” genre. Furthermore, the newly discovered genre can be named via identifying which properties were found to be in common that caused the clustering event. When a genre is discovered or identified, the information can be brought to bear on how best to positing the product in the market place.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A genre discovery engine, the engine comprising:
a product database storing a plurality of product objects, each object comprising product properties;
a genre database storing a plurality of known genre objects corresponding to established clusters of products having correlated product properties where each genre object comprises define criteria for a corresponding identified genre;
a clustering engine coupled with the product database and configured to identify a new cluster of products having one or more correlations of product properties, where the new cluster falls outside a defined criteria for known genres; and
a genre presentation interface coupled with the clustering engine and configured to present the new cluster to a user.

2. The engine of claim 1, wherein the product properties are normalized according to a universal namespace.

3. The engine of claim 1, wherein the correlations comprise combinations of two or more correlated properties.

4. The engine of claim 1, wherein the product properties include at least one of the following:
size, weight, color, specified genre, review score, release date, designer, art style, delivery method, distributor, branding and rating information.

5. The engine of claim 1, wherein the defined criteria comprises contours.

6. The engine of claim 1, wherein the new cluster comprises at least 10 products having properties in common.

7. The engine of claim 6, wherein the new cluster comprises at least 50 products having properties in common.

8. The engine of claim 1, wherein the new clusters comprises products across multiple product classifications.

9. The engine of claim 1, wherein the clustering engine is configured to recommend a genre identifier for the new cluster.
